(19) United States
(12) Patent Application Publication
(10) Pub. No.: US 2022/0078605 A1
(43) Pub. Date: Mar. 10, 2022

(54) METHOD FOR HANDLING OF TERMINAL CAPABILITIES IN A WIRELESS COMMUNICATION NETWORK

(71) Applicant: SONY GROUP CORPORATION, Tokyo (JP)

(72) Inventors: Svante ALNÅS, Lund (SE); Torgny PALENIUS, Barsebäck (SE)

(21) Appl. No.: 17/416,479

(22) PCT Filed: Dec. 11, 2019
(86) PCT No.: PCT/SE2019/051267

§ 371 Date: Jun. 19, 2021

(30) Foreign Application Priority Data
Jan. 9, 2019 (SE) 1950018-0

(51) Int. Cl. H04W 8/24; H04W 76/10; H04W 36/08; H04W 48/02

(52) U.S. Cl. CPC H04W 8/24; H04W 48/02; H04W 36/08; H04W 76/10

(57) ABSTRACT

A method for use in an access network (200) of a wireless communication system (60), for handling capability information of a User Equipment UE (1), comprising transmitting (403), from a first access node (20) of the access network to the UE, a capability enquiry message (43) identifying a first parameter filter (41); receiving (407), in the first access node from the UE, a capability information message (44) identifying capability information associated with the first parameter filter; storing (408) the capability information (45) in the first access node; transmitting (411), from the first access node to a second access node (30), a message (47) identifying the capability information and the first parameter filter.

### TECHNICAL FIELD

This disclosure relates to methods and devices for handling capabilities of a terminal in a wireless communication system including an access network and one or more terminals. More specifically, solutions are provided for identification and transmission of capabilities between various entities within the network.

### BACKGROUND

In wireless communication systems, such as various generations provided through the 3rd Generation Partnership Project (3GPP), various generations of specifications have been provided for setting up common rules for setting up and operating both a wireless radio interface between a wireless terminal and a base station, and various levels of operation of the wireless network. In 3GPP documentation, a wireless terminal, or wireless communication device, is commonly referred to as a User Equipment (UE). A base station defines a cell and is operative to serve a surrounding area with radio access for UEs, by providing radio access to UEs within a cell. A base station is also referred to herein as a node or access node, and various terms are used in 3GPP for different types of systems or specification. An access network, or Radio Access Network (RAN), typically includes a plurality of access nodes, and is connected to a Core Network (CN) which inter alia provides access to other communication networks. In the so-called 3G specifications, also referred to as the Universal Mobile Telecommunications System (UMTS), the term NodeB is used to denote an access node, whereas in the so-called 4G specifications, also referred to as Long-Term Evolution (LTE), the term eNodeB (eNB) is used. A further developed set of specifications for radio communication are referred to as the 5G type radio communication system (5GS), including the New Radio (NR) technology, wherein the term gNB is used to denote an access node.

UEs can have many different capabilities, such as radio capabilities, e.g., associated with modem properties or supported functionality in the UE. In order to make various entities of the wireless network aware of the capabilities supported by a certain UE, the UE indicates its capabilities to the wireless network. This is typically accomplished when the UE registers with the wireless communication network. The capabilities can be indicated in different formats, e.g., in terms of parameters or indicators listed in one or more information elements of a message.

In general, the UE may indicate multiple different capabilities, which may for example concern frequency bands of a wireless communications system, supported frequency band combinations, support of different modulation and demodulation formats, maximum data demodulation rate, 3GPP release version, or specific functions such as relaying or the support of device-to-device communication. In the existing technology, the UE capabilities are indicated in a rather static manner to the network. The capabilities may be indicated upon initial network registration and in some handover scenarios, in response to the network sending a UE capability enquiry. For initiating an update of the capability information from the UE side, the UE may need to re-register in the network.

With the increasing amount of UEs operating in the wireless networks, and the concurrently increasing number of supportable services, features, radio frequency bands etc., the data size of the UE capabilities continues to grow. Current 3GPP releases already have problems with the size of the capabilities. Studies approved within 3GPP to investigate ways of improvement have suggested allocating static capabilities ID per vendor & model or hash for the complete set of capabilities. However, these solutions may be deemed to be too static and inconvenient when part of the capability is changed. In addition to this, it is possible to dynamically indicate different changes in capabilities temporarily, for example if the UE is temporarily overheated it could signal that temporary some RAT's will be disabled (not available).

It is furthermore unrealistic that it will be possible to conveniently store the standardize the UE capability in a central database owned by the operators or manufactures together.

Accordingly, there is a need for techniques that allow for efficiently indicating supported capabilities of a UE or similar wireless communication device to the wireless communication network and in an efficient way communicate this internally within the 3GPP network, both within the access network and to/from the core network.

### SUMMARY

A general object is to provide improved solutions for handling UE capability information in a wireless communication system. In particular, an aspect of this object is to minimize the amount of signaling or data required for conveying capability information, within the wireless network and between the wireless network and the UE. This includes identification, storing and transmission of such UE capability information. This is provided by means of the solutions laid out in the independent claims. Further advantageous embodiments are laid out in the dependent claims.

According to a first aspect, a method is provided for use in an access network of a wireless communication system, for handling capability information of a UE, comprising

transmitting, from a first access node of the access network to the UE, a capability enquiry message identifying a first parameter filter;

receiving, in the first access node from the UE, a capability information message identifying capability information associated with the first parameter filter;

storing the capability information in the first access node;

transmitting, from the first access node to a second access node, a message identifying the capability information and the first parameter filter.

A technical effect thereof is that the second access node will obtain information which it can trust, whereby the need for further signaling over an air interface with the UE can be limited.

In one embodiment, transmitting to the second access node is carried out based on determining connection initiation between the UE and the second access node. By only transferring capability and filter information when needed, signaling within the network may be minimized.

In one variant, said connection initiation includes determining a connection initiation associated with the UE entering a connected state. This may involve that the capability information is transferred to the second access node when the UE enters a connected state, such as RRC_Connected, with respect to the second access node.

In another variant, said connection initiation includes determining handover initiation of the UE from the first access node to the second access node.

In one embodiment, the first parameter filter comprises a list of Radio Access Technologies or a list of frequency bands supported by the first access node, and wherein the capability information identifies combinations of said frequency bands supported by the UE. In such an embodiment, the first parameter filter may thus be conveniently used to obtain information in the first access node of radio capabilities of the UE relevant for that access node, while being able to filter out information that is not relevant for the first access node so as to minimize the amount of data transmitted over the air.

In one embodiment, the information on the first parameter filter is included in the capability information received from the UE. In such an embodiment, the capability information received may be stored and subsequently transferred to a second access node when needed, without further data manipulation in the first access node.

In one embodiment, the method comprises

combining the information on the first parameter filter and data identifying the capability information in a capability message in the first access node;

transmitting the capability message to the second access node over an intra-access node interface. By configuring access node to compile received capability information with the applied parameter filter used to obtain that information, information on the filter need not be duplicated by the UE when reporting its capability.

In one embodiment, the received capability information message includes a capability ID that uniquely identifies a set of UE capabilities associated with the first parameter filter. This way, transmission of large amounts of data of the capability information may be avoided, thereby minimizing air traffic.

In one embodiment, the method comprises

transmitting, from the second access node to the UE, an auxiliary capability enquiry message identifying an auxiliary parameter filter. This way, the second access node may obtain additional or other information as needed, which is not relayed from the first access node.

In one variant, the step of transmitting an auxiliary capability enquiry message is carried out based on determining, in the second access node, that the second access node supports frequency bands or RATs not identified by said first parameter filter.

In one variant, the second parameter filter identifies a list of frequency bands or identification of Radio Access Technologies not supported by the first access node.

According to a second aspect, a method for use in an access node of an access network is provided, for handling capability information of a UE in a wireless communication system, comprising

determining initiation of connection with the UE;

receiving a message from a further access node of the access network, identifying capability information associated with the UE and a first parameter filter associated with the capability information;

correlating the first parameter filter with a second parameter filter associated with the access node to determine need to transmit a capability enquiry message to the UE.

This way, the need for additional capability requests may be minimized.

In one embodiment, the method comprises

determining an auxiliary parameter filter, based on determining, that the access node supports UE features not identified by said first parameter filter;

transmitting a capability enquiry message to the UE, identifying the auxiliary parameter filter.

This way a smaller set of data than full capability information may be requested to be sent from the UE.

In one embodiment, said UE features are frequency bands or identification of Radio Access Technologies.

According to a third aspect, an access node of an access network is provided, configured to handle capability information of a UE in a wireless communication system, comprising

a logic configured to control the access node to carry out any of the steps of the aforementioned embodiments.

In one embodiment, the logic node comprises controller connected to a data storage device, wherein the controller is configured to instructions stored in the data storage device to carry out operation of the access node according to any of the aforementioned steps.

According to a fourth aspect, a computer program product is provided, comprising instructions which may be stored in a data storage device of a logic in an access node, wherein execution of the computer program product by a controller connected to the data storage device configures the access node to carry out operation according to any of the aforementioned steps.

It should be understood that the embodiments and examples outlined herein may conveniently be combined, except were clearly presented as alternatives.

### BRIEF DESCRIPTION OF THE DRAWINGS

Various embodiments will be described with reference to the drawings, in which

FIG. 1 schematically illustrates a network of a wireless communication system including networks nodes according to various embodiments;

FIG. 2 schematically illustrates elements included in a UE configured in accordance with various embodiments;

FIGS. 3A-3B schematically illustrate elements included in access nodes configured in accordance with various embodiments;

FIG. 3C schematically illustrate elements included in a core network node configured in accordance with various embodiments;

FIG. 4 shows a flow chart including several method steps carried out in various nodes in a wireless communication system, where different steps may be included in different embodiments as outlined in further detail below;

FIG. 5 schematically illustrates configuration of data of UE capability information and calculation of corresponding UE capability IDs, in accordance with various embodiments; and

FIG. 6 shows a flow chart including several method steps carried out in various nodes in a wireless communication system, where different steps may be included in different embodiments as outlined in further detail below.

### DETAILED DESCRIPTION OF EMBODIMENTS

The invention will be described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

It will be understood that, when an element is referred to as being “connected” to another element, it can be directly connected to the other element or intervening elements may be present. In contrast, when an element is referred to as being “directly connected” to another element, there are no intervening elements present. Like numbers refer to like elements throughout. It will furthermore be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

Well-known functions or constructions may not be described in detail for brevity and/or clarity. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of this specification and the relevant art and will not be interpreted in an idealized or overly formal sense expressly so defined herein.

Embodiments of the invention are described herein with reference to schematic illustrations of idealized embodiments of the invention. As such, variations from the shapes and relative sizes of the illustrations as a result, for example, of manufacturing techniques and/or tolerances, are to be expected. Thus, embodiments of the invention should not be construed as limited to the particular shapes and relative sizes of regions illustrated herein but are to include deviations in shapes and/or relative sizes that result, for example, from different operational constraints and/or from manufacturing constraints. Thus, the elements illustrated in the figures are schematic in nature and their shapes are not intended to illustrate the actual shape of a region of a device and are not intended to limit the scope of the invention.

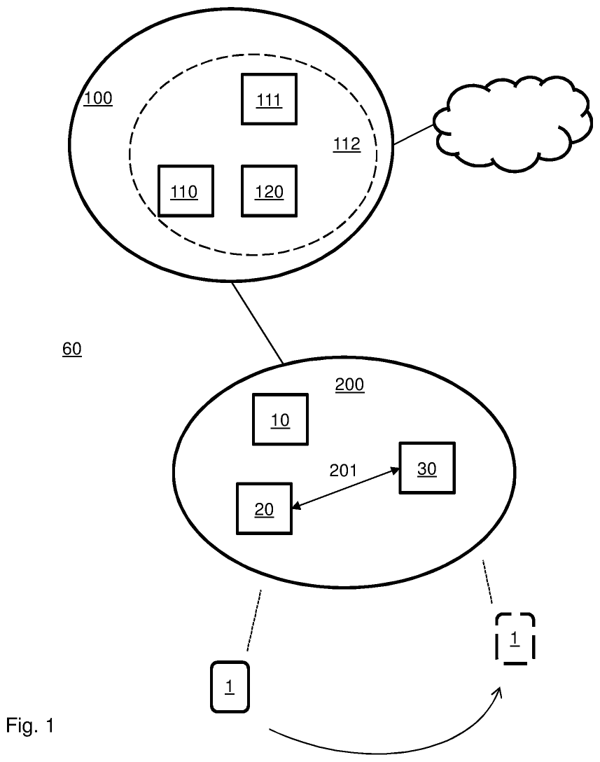

FIG. 1 schematically illustrates a wireless communication system 60, including an access network 200. The access network 200 is in turn connected to a core network 100, which provides access to other communication networks, such as the Internet. The access network 200 may include a plurality of access nodes 10, 20, 30 configured to serve various cells. The access network 200 may e.g. be a Radio Access Network (RAN). A UE 1 is a wireless device configured to communicate wirelessly with access nodes of the access network 200, such as by radio. UEs may be stationary or mobile.

Each access node 10, 20, 30 may in various embodiments be referred to as a base station, serving one cell each. The access network 200 may comprise a number of subareas, which may be referred to as RAN Notification Areas (RNA). Each RNA may consist of a number of cells, where each cell is served by one access node 20. One of those cells may be referred to as an anchor cell. The anchor cell includes the access node 20 that has configured interface to the core network 100 for Control plane and User plane, referred to as N2 and N3 interfaces in 5G. Corresponding interfaces S1-C and S1-U are provided in LTE. The access nodes 10, 30 of the other cells of the RNA may be connected to the anchor cell 20 by means of a logical inter-node interface 201. In 5G, this interface, or set of interfaces, is referred to as Xn interface, and has a similar purpose as the X2 interface defined for LTE.

The CN 100 may include various core network nodes 112 in the form of or comprising entities, nodes or functions 110, 111, 120, defined in accordance with a certain 3GPP release or in accordance with another set of wireless communication standards. Such CN entities may e.g. include a node 110 for handling mobility of UEs, such as an Access & Mobility management Function (AMF) and Session Management Function (SMF). The CN may further include a User Plane Function UPF 120, or gateways 111, such as one or more of a Serving Gateway and a PDN Gateway.

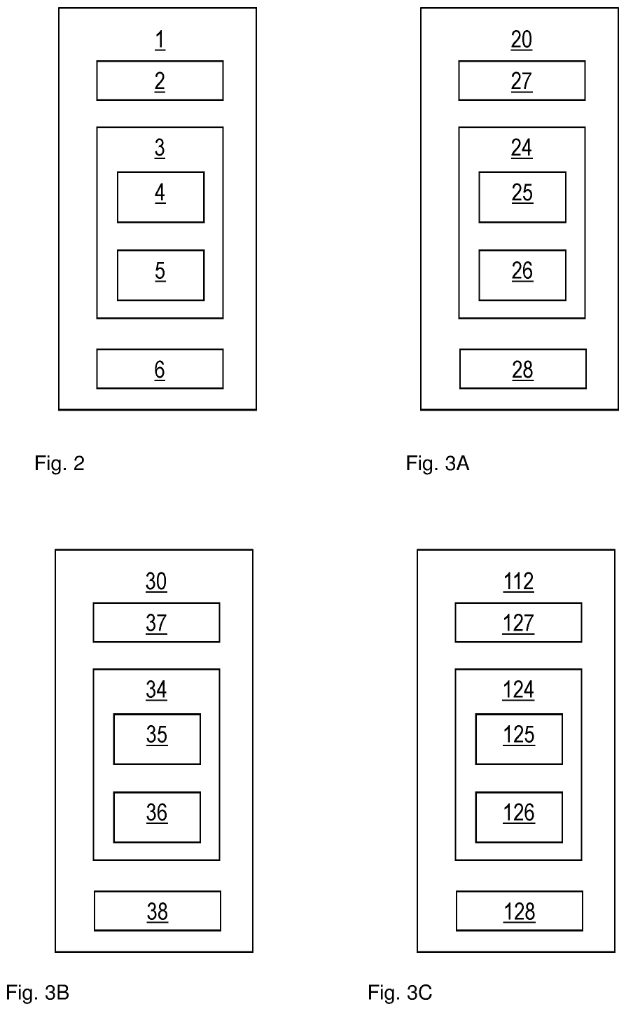

FIG. 2 schematically illustrates a UE 1. The UE 1 may be configured for communication with an access network 200, and comprise a transceiver 2, such as a radio receiver and transmitter for communicating with the access network 200 through at least an air interface. The terminal 1 further comprises a logic 3. The logic 3 may comprise for example a controller or microprocessor 4. The logic may also comprise or be connected to a data storage device 5 configured to include a computer readable storage medium. The data storage device 5 may include a memory and may be, for example, one or more of a buffer, a flash memory, a hard drive, a removable media, a volatile memory, a non-volatile memory, a random access memory (RAM), or other suitable device. In a typical arrangement, the data storage device 5 includes a non-volatile memory for long term data storage and a volatile memory that functions as system memory for the controller 4. The data storage device 5 may exchange data with a processor 4 of the logic 3 over a data bus. The data storage device 5 is considered a non-transitory computer readable medium. One or more processors of the logic 3 may execute instructions stored in the data storage device or a separate memory in order to carry out operation of the UE 1, as outlined herein. The UE 1 may further comprise a data memory 6 for storing UE capability information and associated data. The data memory 6 may be or form part of the data storage device 5, or be a separate entity, but is specifically indicated in the drawing to identify the intended difference between storing code associated with a computer program or operating system in data storage 5 used for controlling and operating the UE 1, from capability data which can be accessed and sent to other nodes of the wireless system 60. It may be noted that the UE 1 clearly may include other features and functions than those identified, such as e.g. one or more antennas, a user interface, a power source and so on, but these components are not shown in FIG. 2 for clarity reasons.

FIG. 3A schematically illustrates an access node 20, also referred to herein as a first access node 20 or auxiliary access node 20, whereas FIG. 3B which schematically illustrates another access node 30, also referred to herein as a second access node 30. In various embodiments, the first 20 and second 30 access nodes may be similar or even identical. In other embodiments, they may be more or less different, and have different radio capabilities in terms of e.g. supported radio access technology (RAT), supported frequency bands and band combinations. In terms of functional entities, the first 20 and second 30 access nodes comprise corresponding elements or functions. In this respect, each access node 20, 30 comprise an access node logic 24, 34. The access node logic 24, 34 may comprise for example a controller or microprocessor 25, 35. The logic 24, 34 may also comprise or be connected to a data storage device 26, 36 configured to include a computer readable storage medium. The data storage device 26, 36 may include a memory and may be, for example, one or more of a buffer, a flash memory, a hard drive, a removable media, a volatile memory, a non-volatile memory, a random access memory (RAM), or other suitable device. In a typical arrangement, the data storage device 26, 36 includes a non-volatile memory for long term data storage and a volatile memory that functions as system memory for the control unit. The data storage device 26, 36 may exchange data with a processor of the logic 24, 34 over a data bus. The data storage device is considered a non-transitory computer readable medium. One or more processors 25, 35 of the logic 24, 34 may execute instructions stored in the data storage device or a separate memory in order to carry out operation of the access node 20, 30, as outlined herein. Each access node 20, 30 may comprise more components, for example a power supply, but these components are not shown in FIGS. 3A and 3B for clarity reasons. The access nodes 20, 30 may further comprise one or more transceivers 27, 37 for communication with other entities. For example, the transceiver 27, 37 may comprise a radio transceiver connected to an antenna arrangement (not shown), for communication over an air interface with the UE 1. Moreover, the transceiver 27, 37 may define one or more interfaces to the core network 100. The access nodes 20, 30 may further comprise a data memory 28, 38 for storing UE capability information and associated data, preferably for a plurality of UEs. The data memory 28, 38 may form part of the data storage device 26, 36 or be a separate entity. Indeed, the data memory 28, 38 may be located centrally accessible for a number of access nodes 10, 20, 30, e.g. in a memory 28, 38 dedicated to several access nodes that may or may not be part of the same RNA.

FIG. 3C schematically illustrates a core network (CN) node 112, which may include one or more parts of the nodes 110, 111, 120 outlined with reference to FIG. 1. The core network node 112 which comprises a CN node logic 124. The CN node logic 124 may comprise for example a controller or microprocessor 125. The logic 124 may also comprise or be connected to a data storage device 126 configured to include a computer readable storage medium. The data storage device 126 may include a memory and may be, for example, one or more of a buffer, a flash memory, a hard drive, a removable media, a volatile memory, a non-volatile memory, a random access memory (RAM), or other suitable device. In a typical arrangement, the data storage device 126 includes a non-volatile memory for long term data storage and a volatile memory that functions as system memory for the control unit. The data storage device 126 may exchange data with a processor of the logic 124 over a data bus. The data storage device is considered a non-transitory computer readable medium. One or more processors 125 of the logic 124 may execute instructions stored in the data storage device or a separate memory in order to carry out operation of the CN node 112, as outlined herein. The CN node 112 may comprise more components, for example a power supply, but these components are not shown in FIG. 3C for clarity reasons. The CN node 112 may further comprise one or more transceivers or interfaces 127 for communication with other entities. For example, the interface 127 may comprise an interface for communication with other networks, e.g. the Internet. Moreover, the interface or transceiver 127 may define one or more interfaces to the access network 200. The CN node 112 may further comprise or be connected to a data memory 128 for storing UE capability information and associated data, preferably for a plurality of UEs. UE capability data of the data memory 128 may physically be stored in a separate memory unit, centrally in the CN 100, whereas the data memory 128 forms a database pointing to or giving access to such separately stored UE capability data.

As noted, a UE 1 may transmit UE capability information, e.g. stored in memory 6, to the access network 200. This may e.g. be accomplished by transmitting a bitmap to indicate its capabilities to the wireless communication network. The receiving access network may store the capability information in data memory 28 and may further convey that data to the CN for central storage in data memory 128. For indicating its capabilities to the wireless communication network, the UE 1 may send a bitmap to an access node 20. This may be accomplished upon initial registration of the UE 1 with the access network 200. However, in some scenarios the bitmap could also be transmitted at a later point of time. For example, the UE 1 could transmit the bitmap while maintaining a connection to the access network 200, e.g., for indicating an update of its capabilities. The bitmap may include a plurality of bits from which subsets of one or more bits indicate whether or not, and optionally also in which way, a certain capability is supported by the UE 1. For example, a single bit of “1” could indicate that the capability is supported. A subset of multiple bits could indicate one of multiple options of supporting a certain capability, a level of support, e.g. distinguishing between no, basic, and full support, and/or one or more parameters related to the capability, e.g. a maximum supported bitrate when using the capability. The mapping of capabilities to bit positions in the bitmap may be preconfigured in the UE 1 and the access node 20. Such pre-configuration may be based on a telecommunication standard and may be based on factory settings or on operator defined settings. Accordingly, the support of a certain capability may be indicated in a binary manner (e.g., by a single bit indicating either “supported” or “unsupported”), but also be indicated by multiple bits, e.g., to indicate a level of support, a selected option, or one or more parameters related to the capability.

In 3GPP terminology, a UE capability report is sent over the radio interface from the UE 1 to the RAN node of the serving cell, such as access node 20, when the UE 1 registers to the network 200. The network 200 requests the UE 1 to send the relevant capabilities in the message “UE Capability Enquiry”. The UE responds with the message “UE Capability Information”. The UE Capability Enquiry may typically contain the filters which the uplink UE capability information is based on. The UE capability information can be sent between the RAN nodes 10, 20, 30 every time the UE makes a handover to another RAN node. Thereby there is no need for the UE 1 to send the capability every time. One problem is that the UE 1 sends the data filtered by the network parameters for one access node 20, which transmitted the request message UE Capability Enquiry. After a handover, the access node 30 of the new cell gets information of the UE capability information but it does not know the filtering that the report is based on.

As will be discussed further below, various embodiments may involve sending IDs that refers to different sets of UE capabilities, rather than the full data of the UE capability information. Different solutions may be employed for this purpose. In one example, an ID is allocated to a certain set of capabilities by the network 200 where the UE 1 is registered. Then, when the UE 1 has sent the capabilities to the network 200 it will receive an ID in response which can be used as long as the UE 1 is within the PLMN. Another possibility is that there is a global database where every phone makers presents the capabilities of their models and a global ID of the set of capabilities is generated. Another alternative is that the Capability ID is defined by a vendor unique ID that identify the vendor and one ID assigned by that vendor. The vendor unique ID may not be a single ID to identify that vendor, it may be the part of the TAC code that is assigned to a specific vendor. If the distribution of capabilities utilizing capability ID within the network 200 is employed, the signaling of the full capabilities over the radio interface can be rare. The distribution of the capabilities between the access nodes 10, 20, 30 can be done through the IDs and then the next access node 30 in a handover can fetch the correct set of capabilities based on the ID. However, before all access nodes in the network 200 and all UEs 1 uses this database with the updated IDs there will be a mixed setup of distributing capabilities.

For UEs supporting many frequency bands and band combinations in earlier releases there is a problem sending the full capabilities over the radio interface. Therefore, the capabilities available in the network 200 are filtered according the available functionality in the access node. For a normal UE 1 today, it is a big common problem that the total set of capabilities that current UE's are supporting does not fit into the message structure of the Capability Enquiry message. Therefore, it is very common to filter the capabilities so that the UE only need to answer with a subset of the implemented/supported capabilities. The current filtered mechanism is defined so that the network 200, and specifically the access node 20 sending the capability enquiry message, will send detailed filter information to the UE 1 so the UE 1 knows exactly what capabilities that should be excluded in the response message and that the response message contains high level information on how the filter was performed. When the network 200 performs a handover to a second access node 30 for the UE 1, a UE context that is transferred to the new access node 30 contains the UE capabilities. The reported capabilities that the access node 20 has received from the UE 1 may contain some information on what filter that the access node 20 requested from the UE 1. The reported capability is the same regardless if the feature is not supported or not requested by the access node 20. The reported capabilities from UE 1 are however not sufficient for the second access node 30 to use to evaluate the supported features of the UE 1. For example if the reported capability does not contain support for NR, the second access node 30 does not know if it is because of that the UE does not support it or the access node 20 did not ask for it.

As noted, the capabilities reported by the UE 1 to the network 200 may be filtered, thereby limiting the size of the capability report. The filtering may be requested in the RRC message “Capability Enquiry” from the access node 20 to the UE 1. The UE Context in the access node 20, where the capability information is stored, does however not include the filter used, in the state of the art. That is not a problem for the current access node 20 since it has requested the capabilities it is interested in, but when transferring the capabilities to another access node 30, which may support other RATs (such as NR in addition to LTE), frequency bands etc., the information of the filtering is very important. However, when the second access node 30 does not know the detailed filtering the capability report is based on, it must in many cases request a new UE Capability Information report from the UE 1 just because it does not know whether the filtering is relevant or not.

According to various embodiments outlined herein, this problem is overcome by attaching the filter definition to the UE Capability information stored in the first access node 20, and signaled over an intra-access node interface, such as the S1 or X2/Xn, e.g. during handover or upon a connection initiation associated with the UE 1 entering a connected state with the second access node 30. When the used filter is included the new access node 30 will obtain knowledge of what filter is used. In case something is missing, e.g. capability related to certain RATs, frequency bands or band combinations which the second access node 30 operates with, the second access node 30 may only request the missing parts of the capability information. More specifically, the second access node 30 will obtain information which it can trust. As an example, if the capability information does not indicate support for a certain parameter, e.g. a certain RAT, but this parameter is included in a first parameter filter applied in the capability enquiry message transmitted from the network 200 to the UE 1, there is no need to send a new capability enquiry message from the second access node 30 to the UE 1. This may also solve the problem for the second access node 30 that in current system when the UE does not indicate support a specific feature, such as Radio Access Technology (RAT) it could be due to that the first access node 20 did not request information on a certain RAT or the UE does not support it.

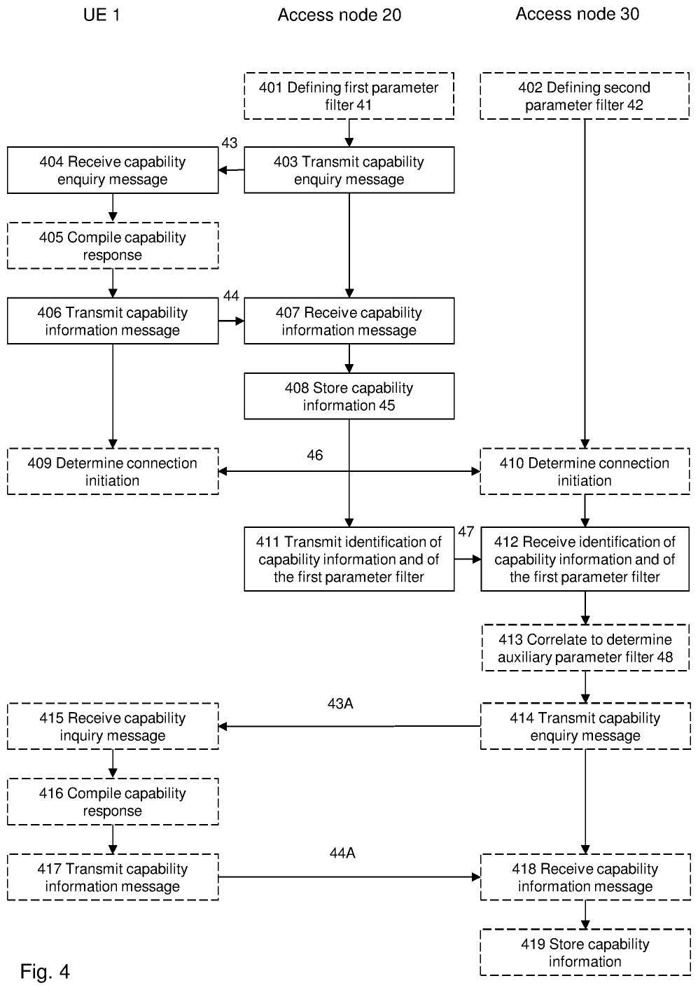

FIG. 4 schematically illustrates a flow chart, in which method steps for and communication between various parts of a wireless communication system 60 are outlined. Specifically, the flow chart provides steps related to a UE 1, a first access node 20 and a second access node 30. In various embodiments, a subset of the steps of FIG. 4, such as only those drawn in full lines, may be included, whereas other embodiments may include more, or all, step provided in the drawing. With reference to FIG. 1, the access nodes 20, 30 for part of an access network 200 of the wireless communication system 60 and may configured to operate as base stations for different cells of a cellular communication system 60. In order to operate conveniently with the access network 200, the UE is configured to convey information to the network about its capability, such as radio capabilities.

In step 401, a first parameter filter 41 may be defined in or for the first access node 20. The first parameter filter 41 may be configured to define parts or details of UE capability information which are relevant to the first access node 20, such as UE supported RAT, radio frequency bands or frequency band combinations, or other UE capabilities as outlined herein, that may be important or required by the first access node in order to communicate over an air interface with a UE. In some embodiments, the first parameter filter 41 thus comprises a list of RATs requested by the first access node.

In step 402, quite similarly, a second parameter filter 42 may be defined in or for the second access node 30. The second parameter filter 42 may thus correspondingly be configured to define parts or details of UE capability information which are relevant to the second access node 30.

In step 403, the first access node 20 transmits a capability enquiry message 43 to a UE 1, typically over an air interface. The capability enquiry message 43 identifies the first parameter filter 41. In various embodiments, the first parameter filter may include a list of one or more parameters for which capability information of the UE 1 is requested, such as e.g. a RAT or frequency band list. In some embodiments, such a list may be included in the capability enquiry message 43, whereas in other embodiments, the capability enquiry message 43 may include a code or other data which may be linked or mapped to the list in the UE 1, e.g. by means of a lookup table, or by using a hash function stored in the UE 1.

In step 404, the UE 1 receives the capability enquiry message 43, which identifies the first parameter filter 41.

In step 405, in response to receiving the capability enquiry message 43, the UE 1 may compile a capability response. Where the received first parameter filter 41 does not explicitly provides what information is requested, this may involve retrieving that information by processing the first parameter filter 41 in the UE 1, e.g. by means of addressing a lookup table or decoding the first parameter filter 41, as exemplified. This step may alternatively, or additionally, comprise preparing parts or details of the complete UE capabilities of the UE 1, in accordance with the first parameter filter 41.

In step 406, the UE 1 may transmit a capability information message 44 to the first access node 20. The capability information message 44 identifies capability information associated with the first parameter filter 41. In this respect, the capability information message 44 may specifically identify if one or more features, such as one or more RAT types, identified as a parameter enquired for in the first parameter filter, are supported by the UE 1.

In step 407, the first access node 20 receives the capability information message 44 from the UE 1.

In step 408, the first access node 20 stores capability information 45 associated with the UE 1. In one embodiment, this may be the capability information 45 as received in the capability information message 44 in step 407. In an alternative embodiment, e.g. if the capability information message 44 is provided as a capability ID rather than explicit data of the capability information, the step of storing 408 may include storing only that ID with reference to the UE 1, or retrieving the capability information from data storage, in the access node 20 or in the core network 100, or e.g. by using a hash function, associated with the received capability information message 44. The capability information 45 may identify combinations of frequency bands supported by the UE and associated with the RATs requested by the first access node 20, and/or include UE radio capabilities associated with a predetermined feature set of radio communication. The predetermined feature set may be associated with any of Voice over LTE (VoLTE), Internet of Things (IoT), Ultra-Reliable Low-Latency Communication (URLLC) or other feature.

In step 411, the first access node 20 may transmit a message 47 identifying the capability information 45 for the UE 1, and the first parameter filter, to a second access node 30. Again, this may be carried out by transmitting explicit capability information for the UE 1 as stored, or only an ID which is uniquely associated with that capability information for the UE 1. In various embodiments, the step of transmitting a message 47 may involve transmitting filtered capability information 45 and the first parameter filter 41 in separate messages. In various embodiments, this step may involve adding, by the first access node 20, information on RAT to the received capability information, which may include information on supported frequency bands or band combinations, in the message or messages 47 signaled to the second access node. As an example, the first access node may be configured to operate under LTE RAT, and has requested capability information from the UE 1 in the capability enquiry message 43 with respect to a number of frequency bands or band combinations. The second access node 30 may be configured to operate under different RATs than the first access node 20, such as NR in addition to LTE. The capability information 45 received from the UE 1 is then combined, in the first access node 20, with an indication of the RAT (LTE) with which the capability enquiry message 43 was associated. This way, the second access node 30 will obtain knowledge of whether the support at various frequencies indicated by the capability information applies to a certain RAT or nor not.

In step 412, the second access node may receive the identification of capability information and of the first parameter filter, which may include or be added with identification of RAT associated with the first parameter filter 41.

In various embodiments, transmission of the identification of capability information and of the first parameter filter to the second access node 30 may be triggered by detecting or determining connection initiation between the UE 1 and the second access node 30. This may be related to a handover situation, where the UE 1 goes from a connected state in association with the first access node 20 to a connected state in association with the second access node 30. In an alternative scenario, this may involve initiation of a connected state, from e.g. an idle state, of the UE 1. This may e.g. be triggered by the network 200 if a message to the UE 1 is to be transmitted, or by the UE 1 if the UE 1 is to transmit a message, or otherwise requires access to the network 200. This may typically involve RRC signaling.

In step 409, a scenario of the UE 1 determining connection initiation is provided.

In step 410, a scenario of the second access node 30 determining connection initiation is provided.

It may be noted that determining connection initiation between the UE 1 and the network 200 may also include the first access node 20, where said determination is a handover when the UE 1 is connected to the first access node 20.

In step 413, the second access node 30 may correlate the first parameter filter 41 with a second parameter filter 42 associated with the access node 30, to determine need to transmit a capability enquiry message to the UE. This step may involve determining filter features of the second parameter filter 42 not included in the first parameter filter 41. This step may further comprise determining whether the capability information 45 is associated with all RATs supported by the second access node 30. This step may also include determining an auxiliary parameter filter 48 in the second access node 30. Since the second access node 30 has obtained knowledge of the first parameter filter 41 and the UE capability information provided based on that first parameter filter 41, it may be decided by correlation to the second parameter filter 42 if there are further capability parameters which the second access node 30 needs to enquire the UE 1 for. In various embodiments, the auxiliary parameter filter 48 may thus include capability parameters for which no data is provided in the received capability information 45, such as features associated with a certain RAT. In other words, if capability information required according to the second parameter filter 42 has already been provided, as defined by the first parameter filter 41, the auxiliary parameter filter 48 may define a smaller set of data to be enquired, than the full set as defined by the second parameter filter 42.

In step 414, the second access node 30 may transmit a capability enquiry message 43A, based on determining that there are further capability parameters which the second access node 30 needs to enquire the UE 1 for. As an example, it may have been determined that the second access node 30 supports RATs not identified by said first parameter filter 41. Step 414 may include transmitting, from the second access node 30 to the UE 1, a capability enquiry message identifying the auxiliary parameter filter 48 being the same as the second parameter filter 42. In an alternative embodiment, step 414 may involve transmitting a capability enquiry message 43A identifying an auxiliary parameter filter 48, indicating only capability information not received from the first access node 20, rather than transmitting an identification of the full second parameter filter 42. This way, the data requested from the UE 1 may be limited.

In step 415, the capability enquiry message 43A, identifying the auxiliary parameter filter 48, is received in the UE 1.

In step 416, in response to receiving the capability enquiry message 43A, the UE 1 may compile a capability response. Where the received auxiliary parameter filter 48 does not explicitly provides what information is requested, this may involve retrieving that information by processing the auxiliary parameter filter 48 in the UE 1, e.g. by means of addressing a lookup table or decoding a capability ID of the auxiliary parameter filter 41, as exemplified. This step may alternatively, or additionally, comprise preparing parts or details of the complete UE capabilities of the UE 1, in accordance with the auxiliary parameter filter 48.

In step 417, the UE 1 may transmit a capability information message 44A to the second access node 30. The capability information message 44A identifies capability information associated with the auxiliary parameter filter 48.

In step 418, the second access node 30 receives the capability information message 44A from the UE 1.

In step 419, the second access node 30 stores capability information associated with the UE 1. In one embodiment, this may be the capability information as received in the capability information message 44 in step 407 in combination with the capability information message 44A in step 418. In an alternative embodiment, e.g. if the capability information message 44 and/or 44A is provided as a capability ID rather than explicit data of the capability information, the step of storing 419 may include storing only that ID with reference to the UE 1, or retrieving the capability information from data storage, in the access node 30 or in the core network 100, or e.g. by using a hash function, associated with the received capability information message 44 and/or 44A.

In various embodiments, the solutions outlined with reference to the drawings may be combined with the idea to use an ID which defines the UE capability information, such as radio capabilities. As noted, the ID is used to limit signaling between the UE 1 and the access node 20, 30, but can also be used to signal the capabilities between the access nodes during a handover or other connection initiation to limit signaling load. In this case the ID is based on the filtered UE Capability reported from the UE 1.

The filter definition, e.g. the first parameter filter 41, which also is needed in the target access node 30 may either be attached to the capability ID when it is sent 47 between the access nodes, or a new ID may be created on the combination of the set of capability information 45 and the filter 41 combined. In any way the capability ID and filter ID if used can be sent to the new access node 30 and then the capability information and the filter definition can be recreated from the ID or IDs in the receiving node 30.

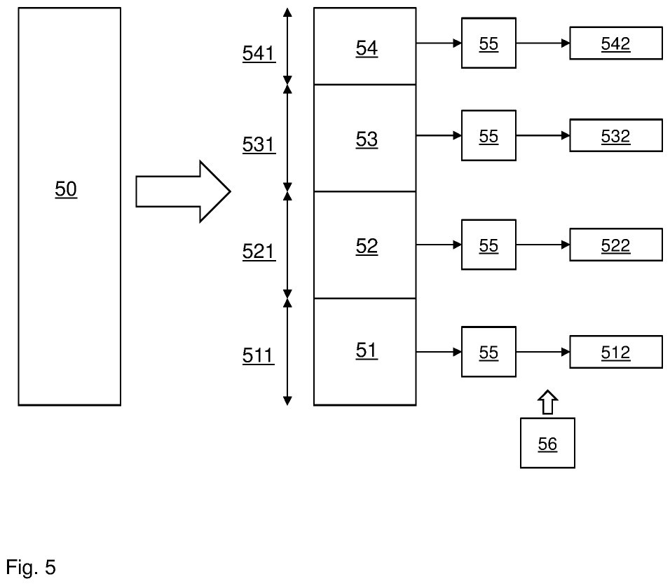

FIG. 5 schematically illustrates an embodiment of reporting capability information using a capability ID, which may be used in conjunction with the embodiments described herein, e.g. with reference to FIG. 4. According to this embodiment, the full UE capability information 50 is split into several blocks of data 51-54, wherein each data block includes or represents a subset of the UE capability information. A separate UE capability identity or ID 512, 522, 532, 542 is determined to identify each block of data. Preferably, the UE capability ID 512 for a block of data 51 is determined as a hash 512, calculated using a predetermined hash mechanism 55 based on the data of the block 51. The hash mechanism 55 may e.g. be SHA-2 or SHA-3, where SHA denotes Secure Hash Algorithm. The hash 512 will always have a specific number of bits, e.g. 128 bits, and constitutes a fingerprint of the data 51. Specifically, a device, such an access node 100, may be able to calculate exactly the same hash 512 using the hash mechanism 55, once it has access to the data of block 51. On the other hand, the complexity of the hash function 55 is such that merely having access to the hash 512 and the hash function 55 is not sufficient to reconstruct the data of the data block 51. In various embodiments, the capability ID 512 may be determined based on the data of the corresponding or associated data block 51 with a less complex function than a hash.

In various embodiments, the capability ID is at least partially determined based on a device manufacturer specific code 56. In one embodiment, a hash is calculated from the data of a data block 51, by means of a hash mechanism 55, and subsequently a device manufacturer specific code 56 may be added to the calculated hash, so as to form the capability ID 512.

The division of the UE capability information into blocks is preferably carried out such that each block 51-54 has a data size 511,521,531,541 determined with respect to a predetermined common maximum data size. A UE or modem manufacturer may thus configure a UE model to divide its UE capability information in any particular way, as long as each data block 51-54 does not exceed a maximum size limit. In preferred embodiments, the maximum size limit may be a payload size of a data message format for conveying data in the wireless communication system 60, either between a UE 1 and an access node 20, or between the access network 200 and the core network 100, or in other interfaces within the core network 100. The maximum size limit may in various embodiments be defined as a number of octets, e.g. as defined in Packet Data Convergence Protocol, specified by 3GPP in TS 25.323 for UMTS, TS 36.323 for LTE and TS 38.323 for 5G New Radio NR, or elsewhere. The maximum size limit may e.g. be a predetermined number of bytes, such as 9000 bytes or 8188 bytes.

In various embodiments, a UE may be configured such that UE capability parameters that may vary and be changed even after registration to a wireless network, are collected in one data block 51. This way, once the UE capability information of that or those data blocks 51 are conveyed to and stored in the network, 200, 100, only the UE capability ID 512 needs to be transmitted when the capabilities of a UE 1 are changed. Furthermore, a UE or modem manufacturer may configure its UE capabilities such that capability information of one or several blocks 51-54 are always or often common for several or all UE models. This way, once the UE capability information of that or those data blocks 51 are conveyed to and stored in the network, 200, 100, only the UE capability ID 512 needs to be transmitted from a newly registered UE 1, and the network 100, 200 can still determine the UE capability information of that UE 1. Furthermore, full UE capability information need only be transmitted from the UE 1 for the blocks 51-54 having new information.

In FIG. 5, data blocks 51-53 have substantially the same size, whereas data block 54 is smaller. As noted, this division may be conveniently made, so as to minimize data transmission in the wireless communication system. In fact, one or more data blocks may be considerably smaller than others, where it is deemed that this or these blocks contain UE capability information that is generally different between UE models or individual UEs, or relates to UE capability information that may often change, such as UE capability information associated with category reduction due to overheating.

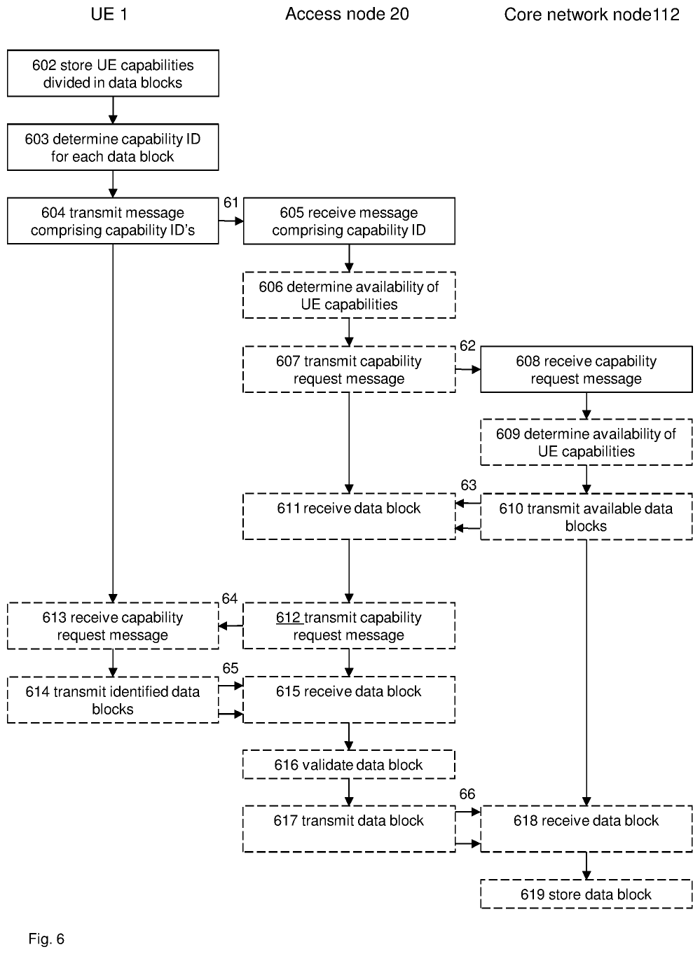

FIG. 6 shows a flow chart, which shows several method steps carried out by entities cooperating in the wireless communication system 60, for conveying capability information using capability IDs. This flow chart describes a way of reporting capability information while minimizing the amount of actual data transmitted, particularly over the air, and the general concept of FIG. 6 may be employed also in embodiments operating as provided with reference to FIG. 4. Moreover, it shall be noted that, while a large number of method steps and messages are indicated, not all those steps and messages need to be included in every embodiment. However, for the sake of convenience, a number of different embodiments will be outlined below with reference to FIG. 6. At least the steps indicated by dashed lines may be optional and included only in certain embodiments.

In the drawing, steps carried out by the UE 1 are shown to the left. These steps may be carried out by means of a UE in accordance with FIG. 2.

Steps carried out in the access network 200 are shown in the middle of the flow chart. These steps may be carried out by means of an access node in accordance with FIG. 3. In FIG. 6, these are exemplified as being carried out by an access node 20. However, it should be clear that various steps of the access network 200 may be carried out by different access nodes 10, 20, 30. A UE 1 may e.g. register to the access network 200 using a first access node 20, and subsequently send updated capability information, or UE capability ID, to the access network 200 through a second access node 30 at a later stage. Also, UE capability information and UE capability ID may be stored in one access node 20 and accessed by another access node 10 of the same access network 200.

Steps carried out in the core network 100 are shown to the right. These steps may be carried out by means of a core network node in accordance with FIG. 4. In FIG. 6, these are exemplified as being carried out in a core network node 112 configured to handle mobility management, such as an AMF of a 5G network. However, steps carried out in the core network 100 may in fact be carried in other or several core network nodes.

With reference to FIG. 6, a method is provided for use in a UE 1 of handling UE capability information in a wireless communication system 60 including an access network 200.

In step 602 the UE stores the UE capabilities information 50 divided into a plurality of data blocks 51-54, wherein each data block includes a subset of the UE capability information. The storing may be provided by the manufacturer of the UE 1, or of a modem in the UE 1. Alternatively, or additionally, various UE capability information may be determined by an operator of the access network 200 and assessed by the UE 1 through access to data on a SIM Subscriber Identity Module such as a UICC Universal Integrated Circuit Card. The actual division into blocks 51-54, of the UE capability information, may in various embodiments be determined by the UE manufacturer.

In various embodiments, each data block, or at least one of the data blocks 51-54, includes UE radio capabilities associated with a predetermined RAT or a radio frequency, or a radio frequency of a RAT. Various embodiment may thus include e.g. three groups of subsets of UE capability information, divided into three blocks 51-53 with capability associated with frequencies 6GHz, 28GHz and 36GHz, respectively.

In some embodiments, each data block, or at least one of the data blocks 51-54, includes UE radio capabilities associated with a predetermined feature set of radio communication. In such embodiments, groups of subsets of UE capability information may be divided into blocks with respective capability information associated with e.g. VoLTE Voice over LTE, IoT Internet of Things, URLLC Ultra-Reliable Low-Latency Communication etc.

In step 603, the UE 1 determines, for each data block, a corresponding capability ID 512,522,532,542. Each capability ID preferably uniquely corresponds to each one data block. Each capability ID 512 is therefore preferably determined based on the data of the associated data block 51, such as a hash or hash value 512 calculated using a predetermined function 55 based on the data of the associated data block 51. In various embodiments, the UE 1 may have a predefined set of UE capabilities, determined by the UE capability information 50, and may have one or more pre-configured data blocks, such as all or only a subset of the blocks 51-54. In addition, the UE 1 may be preconfigured with predetermined capability IDs for each of the pre-configured data blocks. In such an embodiment, the step of determining a corresponding capability ID may comprise accessing the pre-configured capability ID from a memory 6, rather than calculating it.

In step 604, the UE 1 transmits a capability message 61 to the access network 200, comprising at least one of the determined capability IDs, such as all the determined capability IDs. At original registering to the wireless network, preferably the capability IDs 512, 522, 532, 542 corresponding to each data block 51-54 are preferably transmitted. At later update of UE capabilities, only the determined capability IDs of the data blocks that have been changed need to be transmitted. In various embodiments, all determined capability ID available in the UE 1 are always transmitted, whether any capability ID is changed or not, upon registering to a network 200 or upon request by the network 200.

Preferably, each block 51-54 has a predetermined common maximum data size, which may be determined by specification. The maximum data size may be defined by means of a number of bytes or octets, or by reference to another data object or object size. In various embodiments, the maximum data size may be equal to or correlated with a payload size of a defined data message used in the wireless system 60, as exemplified above.

The steps and features described with reference to step 604 may be e.g. be incorporated in step 406 of FIG. 4, wherein message 61 corresponds to message 44.

In step 613, the UE 1 may receive 613 a capability request message 64 from an access node 20 of the access network, identifying at least one of said data blocks. In various embodiments, the capability request message 64 comprises on or more the capability IDs that were transmitted in the capability message 61. In an alternative embodiment, an even simpler identification may be made, such as an identification of the data block order. Where the UE 1 has transmitted e.g. four capability IDSs 512, 522, 532, 542, the capability request message 64 may simply indicate “3, 4” to identify that the data block 53 associated with the third capability ID, and the data block 54 associated with the fourth capability ID, are requested. Receipt of the capability request message 64 indicates that the data block(s) identified in the request message is not available to the access node 20.

In step 614 the UE 1 transmits data blocks corresponding to the capability IDs identified by said capability request message to the access node, in response to receiving the capability request message 64. In the provided example, the UE 1 transmits the third 53 and fourth 54 data blocks. Moreover, since the UE capability information has been divided into blocks, each identified data block 53, 54 is transmitted in a separate message 65 to the access node, hence the indication of two transmissions in the drawing.

In addition to the features related to the UE 1, a method is provided for use in an access node 20 for handling UE capability information in an access network 200 of a wireless communication system 60 including at least one UE 1. Specifically, the method relates to handling or accessing of UE capability information for a UE 1, related to which the access node 20 does not originally have access to the full UE capability information. It may thus be noted that the access node 20 may previously have transmitted to and/or received UE capability information from a core network node 112, or from other UEs, and the core network node may previously have transmitted to and/or received UE capability information from the access network 200. All or some of such previously received UE capability information may be stored in memory 28 in the access network 200, where it is made available to the access node 20. At some point, a UE 1 may register to the network to which the access node 20 belongs, or otherwise wants to update its capability status, and thereby transmits capability IDs.

In a step 605, the access node 20 receives, from the UE 1, a capability message 61 comprising one or more capability IDs 512,522,532,542, wherein each capability ID is associated with a corresponding data block 51-54 including a subset of the UE capability information of said UE 1. At least in the event the UE 1 registers to the network to which the access node 20 belongs, the capability message 61 preferably includes capability IDs corresponding to each data block of capability information for said UE 1.

The features described with reference to step 605 may e.g. be incorporated in step 407 of FIG. 4.

In step 606, the access node 20 determines availability to the UE capability information corresponding to the received capability IDs, such as by accessing data memory 28. Typically, this may include the steps of searching for the received capability ID in a database of memory 28, and, responsive to finding the capability ID in the database, retrieving the associated subset of UE capabilities from the data block to which the capability ID corresponds, from the data memory 28. However, in the event one or more received capability ID is not available to the access node 20, this data must be obtained. This is preferably first 607 attempted from the core network 100, and secondly 612 from the UE 1.

In step 607 the access node 20 transmits a capability request message 62 to a different node in the wireless communication system, identifying the capability ID associated with at least one data block which is not available to the access node 20. As noted, this capability request message 62 may primarily be sent to the core network 100, such as core network node 112.

In step 611, the access node receives 611 said at least one data block from the core network node 112, provided it was available there.

Where the data block corresponding to each capability ID is not available in the access node 20 or obtained 63 from the core network node 112, the UE 1 itself is queried for the missing UE capability information:

In step 612 the access node 20 transmits a capability request message 64 to the UE 1, identifying the capability ID corresponding to the data block which is still not available to the access node 20.

In step 615, the data block still not available is received from the UE 1.

With reference to the embodiment of FIG. 4, the capability information 45 stored in step 408 may thus comprise information received either from the UE 1 or from the core network 100, or a combination of both.

By this arrangement, data transmission over the air is minimized. First by checking locally stored data 28 first, and secondly attempting to obtain said data from the core network. Moreover, by dividing the UE capability information into data blocks, each transmission that is required to convey UE capability information for a certain UE is advantageously minimized, since many or all data blocks containing each one subset of UE capability information may already be available. Furthermore, if UE capability information contained in one block is missing, only the data of that block needs to be sent.

In step 616, the access node 20 may be configured to validate 616 data blocks received 615 by the UE 1 by
calculating a capability ID based on each at least one received 615 data block using a predetermined function 55 for calculating capability IDs;
comparing the calculated capability ID with the received capability ID of the capability message 61.

In step 617, the access node the access node 20 may transmit 617 any data block obtained 65 from the UE 1 to the core network node 112.

In addition to the features related to the UE 1 and the access node 20, a method is provided for use in a core network node 112 for handling user equipment, UE, capability information in a wireless communication system 60 including at least one UE 1 and an access network 200.

In a step 608, the core network node receives, from an access node 20 of the access network, a capability request message 62 comprising one or more capability IDs 512,522,532,542, wherein each capability ID is associated with a corresponding data block 51-54 including a subset of the UE capability information of said UE 1.

In step 609, the core network node may determine availability of the UE capability information corresponding to the received capability IDs.

In step 610, the core network node may transmit all available data blocks corresponding to the received capability IDs to the access node 20.

In step 618, the core network node may receive, from the access node 20, all previously not available data blocks corresponding to the received capability IDs.

In step 619, the core network node may store 619 any data block received from the access node 20, e.g. in a data memory 128, where it is associated with the corresponding capability ID as received 608.

The proposed solutions provide several benefits. Generally, the proposed solutions serve to minimize the amount of data that has to be transmitted between various nodes of a wireless communication system 60, for handling UE capability. Specifically, an increased trust can be obtained regarding UE context received in an access node from another access node in an access network. Furthermore, it is in various embodiments possible to keep existing message size and fit single UE Radio capability block into each one message. In the event of e.g. a software upgrade with only few UE radio capabilities changed, then only the data block including the subset of UE capability information that has changed needs to be transferred and updated. This also allows a flexible solution that allows any implementation to add/change capabilities over time.

1. A method for use in an access network of a wireless communication system, for handling capability information of a User Equipment UE, comprising
transmitting, from a first access node of the access network to the UE, a capability enquiry message identifying a first parameter filter;
receiving, in the first access node from the UE, a capability information message identifying capability information associated with the first parameter filter, wherein the first parameter filter comprises a list of Radio Access Technologies, RATs, requested by the first access node, and wherein the capability information
identifies combinations of frequency bands supported by the UE and associated with the RATs requested by the first access node; or
includes UE radio capabilities associated with a predetermined feature set of radio communication;
storing the capability information in the first access node; and
transmitting, from the first access node to a second access node, a message identifying the capability information and the first parameter filter.

2. The method of claim 1, wherein transmitting to the second access node is carried out based on determining connection initiation between the UE and the second access node.

3. The method of claim 2, wherein said connection initiation includes determining a connection initiation associated with the UE entering a connected state.

4. The method of claim 2, wherein said connection initiation includes determining handover initiation of the UE from the first access node to the second access node.

5. The method of claim 1, wherein the predetermined feature set is associated with any of Voice over LTE, VoLTE, Internet of Things, IoT, and Ultra-Reliable Low-Latency Communication, URLLC.

6. The method of claim 1, wherein the information on the first parameter filter is included in the capability information received from the UE.

7. The method of claim 1, comprising
combining the information on the first parameter filter and data identifying the capability information in a capability message in the first access node;
transmitting the capability message to the second access node over an intra-access node interface.

8. The method of claim 1, wherein the received capability information message includes a capability ID (512) that uniquely identifies a set of UE capabilities associated with the first parameter filter.

9. The method of claim 1, comprising
transmitting, from the second access node to the UE, a capability enquiry message identifying an auxiliary parameter filter.

10. The method of claim 9, wherein the step of transmitting a capability enquiry message is carried out based on determining, in the second access node, that the second access node supports frequency bands not identified by said first parameter filter.

11. The method of claim 9, wherein the auxiliary parameter filter identifies a list of frequency bands not supported by the first access node.

12. A method for use in an access node of an access network, for handling capability information of a UE in a wireless communication system, comprising
determining initiation of connection with the UE;
receiving a message from a further access node of the access network, identifying capability information associated with the UE and a first parameter filter associated with the capability information, wherein the first parameter filter comprises a list of Radio Access Technologies, RATs, requested by the further access node, and wherein the capability information
identifies combinations of frequency bands supported by the UE and associated with the RATs requested by the further access node, or
includes UE radio capabilities associated with a predetermined feature set of radio communication; and
correlating the first parameter filter with a second parameter filter associated with the access node to determine need to transmit a capability enquiry message to the UE.

13. The method of claim 12, comprising
determining an auxiliary parameter filter, based on determining, that the access node supports UE features not identified by said first parameter filter;
transmitting a capability enquiry message to the UE, identifying the auxiliary parameter filter.

14. The method of claim 13, wherein said UE features are frequency bands or identification of RATs.

15. An access node of an access network configured to handle capability information of a UE in a wireless communication system, comprising
a logic configured to execute computer program code to control the access node to carry out the steps of claim 1.
